(19) United States
(12) Patent Application Publication
(10) Pub. No.: US 2019/0037983 A1
(43) Pub. Date: Feb. 7, 2019

(54) FOLDABLE BICYCLE SUNSHADE

(71) Applicants: VERONICA Y. BOURASSA, GLENDALE, AZ (US); KENNETH J. BOURASSA, GLENDALE, AZ (US)

(72) Inventors: VERONICA Y. BOURASSA, GLENDALE, AZ (US); KENNETH J. BOURASSA, GLENDALE, AZ (US)

(21) Appl. No.: 16/054,519

(22) Filed: Aug. 3, 2018

Related U.S. Application Data
(60) Provisional application No. 62/542,185, filed on Aug. 7, 2017.

(51) Int. Cl. A45B 11/00; B62J 11/00

(52) U.S. Cl. CPC A45B 11/00; F16M 13/02; B62J 11/00

(57) ABSTRACT

A bicycle sunshade has a bracket, curved tube, support pole, tipping mechanism and a screen portion. The bracket attaches to a bicycle seat post and has an arm to accept a curved tube. The opposite end of the curved tube is straight and fits inside a support pole. Both the curved tube and support pole have holes for pins to secure the tube and pole together. The tipping mechanism that fits over the support pole. It has a tube with a side hole to accommodate the top of the support pole as the tipping mechanism pivots. The tipping mechanism and support pole are secured by a bolt that serves as a fulcrum. The tipping mechanism also has a plate to engage the screen portion. The screen portion has a perimeter tube that support a valance and attaches to the perimeter of the screen.

### CROSS-REFERENCE TO RELATED APPLICATION

This application claims the benefit of U.S. Provisional Patent Application No. 62/542,185, filed Aug. 7, 2017, the entire contents of which are incorporated herein by reference.

### FIELD OF THE INVENTION

The present invention generally relates to attachable sun shades and more particularly to a new device for shading a person while riding a bicycle.

### BACKGROUND OF THE INVENTION

Consumers are becoming increasingly concerned about protecting themselves from the sun's ultraviolet rays in the outdoors. Simultaneously more people are enjoying the outdoors for more hours. Bicycle usage benefits people in numerous ways, less heart disease, and even less cancer. It benefits society in that more bicycle use coincides with less petrochemical use, less road wear and tear, less noise and less urban congestion. Because of those benefits, many municipalities are establishing bike lanes and even separate bike trails. Biking holidays are encouraged by large biking events, such as the Register's Annual Great Bicycle Ride Across Iowa, which has spawned many similar geographic events. Increasingly popular are weeklong vacations with organized daily bike rides from point to point, supported by luggage transport and accompanying repair vehicles.

Bicycling continues to be very popular, not only as a sport, but also as transportation (touring bicycles) and commuting. It still is used in industry and the military—mail carriers, paramedics, police, messengers and other delivery services, communications, reconnaissance, troop movement, supply delivery and patrol.

In a recent year, over 100 million bicycles were produced and sold. They continue to be a major source of transportation in many third world countries, where ownership of a bicycle can raise family income by 30%. Many emerging economies are discouraging auto vehicle use and supporting continuing bike use to limit congestion and pollution in cities.

### SUMMARY OF THE INVENTION

In one embodiment, a new bicycle sunshade has a bracket, curved tube, support pole, tipping mechanism and a screen portion. The bracket attaches to a bicycle seat post and has an arm to accept a curved tube. The opposite end of the curved tube is straight and fits inside a support pole. Both the curved tube and support pole have holes for pins to secure the tube and pole together. The tipping mechanism that fits over the support pole. It has a tube with a side hole to accommodate the top of the support pole as the tipping mechanism pivots. The tipping mechanism and support pole are secured by a bolt that serves as a fulcrum. The tipping mechanism also has a plate to engage the screen portion. The screen portion has a perimeter tube that support a valance and attaches to the perimeter of the screen.

### BRIEF DESCRIPTION OF THE DRAWINGS

Referring to the drawings:

FIG. 1 is a side plan view of a prototype of an inventive bike shade installed on a bicycle;

FIG. 2 is a transverse view of the bracket on a seat post, arm and curved tube;

FIG. 3 is a detailed view of the bracket and arm, the bracket being fitted over the seat post;

FIG. 4 is a transverse rear view of the sunshade showing the upper part of the support pole and the tipping mechanism to fold the sunshade;

FIG. 5 is a plan view of the upper surface of the screen;

FIG. 6 is a detailed side schematic of the hardware of the sunshade; and

FIG. 7 is a schematic of the rear view of the hardware of the sunshade.

### DETAILED DESCRIPTION

As cyclists ourselves, we appreciate the pro's and con's of the activity. We appreciate the fun of exploring on our bicycles, but can get overheated in the sun. After a particularly hot bicycle ride, we started sketching drawings of what a sun shade should be. We tested prototypes. One we liked unfortunately twisted in use, so we continued to invent. Our current model is sturdier but even simpler and more efficient to manufacture.

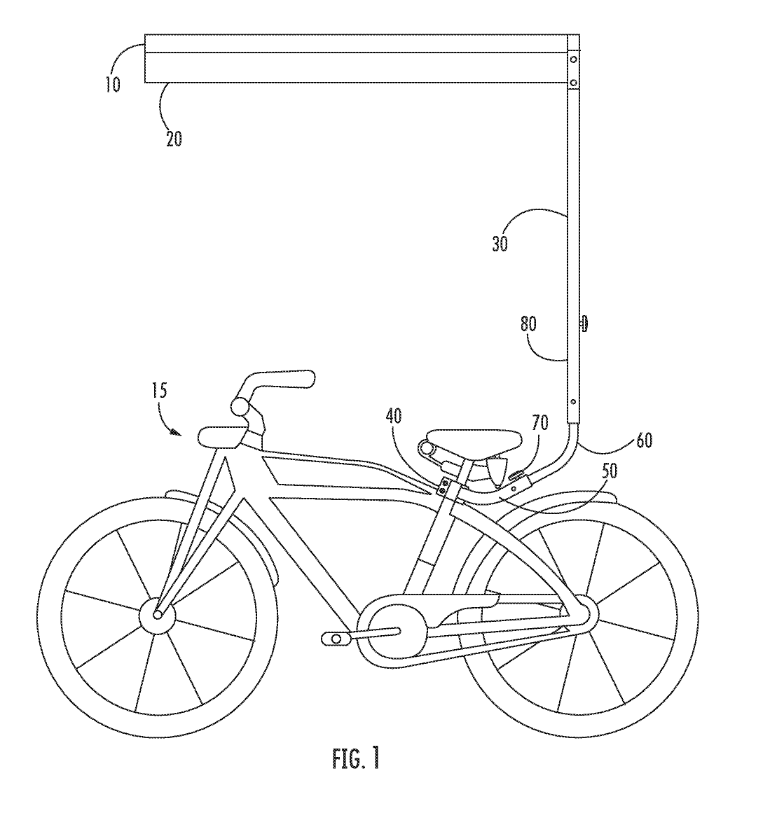

In this embodiment, we disclose a foldable bicycle shade 10 on a standard bicycle 15 in FIG. 1. Here a valance 20 is shown as edging the shade 10. A single telescoping rod 30 supports the shade 10 and attaches it to the bicycle seat post via bracket 40. Because seat posts are variable in diameter, different inserts are available for effectively clamping to the seat post.

The telescoping rod 30 includes at least three parts. Arm 50 connects to the clamp 40. It is intended to remain on the bicycle bracket 40 between uses of the shade 10. Arm 50 does not extend much if at all behind the bicycle seat. The curve of this arm is designed to support the shade behind the seat and avoid encroaching on the rider or the rider's buttocks. In this embodiment, the arm 50 has two holes, one for a pin (not shown) to fix curved tube 60 inside the arm 50. Thumb nut 70 enables tightening the arm 50 curved tube 60 together to avoid movement, including rattling.

Curved tube 60 fits inside support pole 80 that can be raised or lowered about a foot to adjust to the rider's height. After the height (three feet to four feet) is selected, a pin is inserted into a hole in support pole 80 and the height is fine-tuned until the pin slips into an adjacent hole in the curved tube 60. This junction of curved tube 60 and support pole 80.

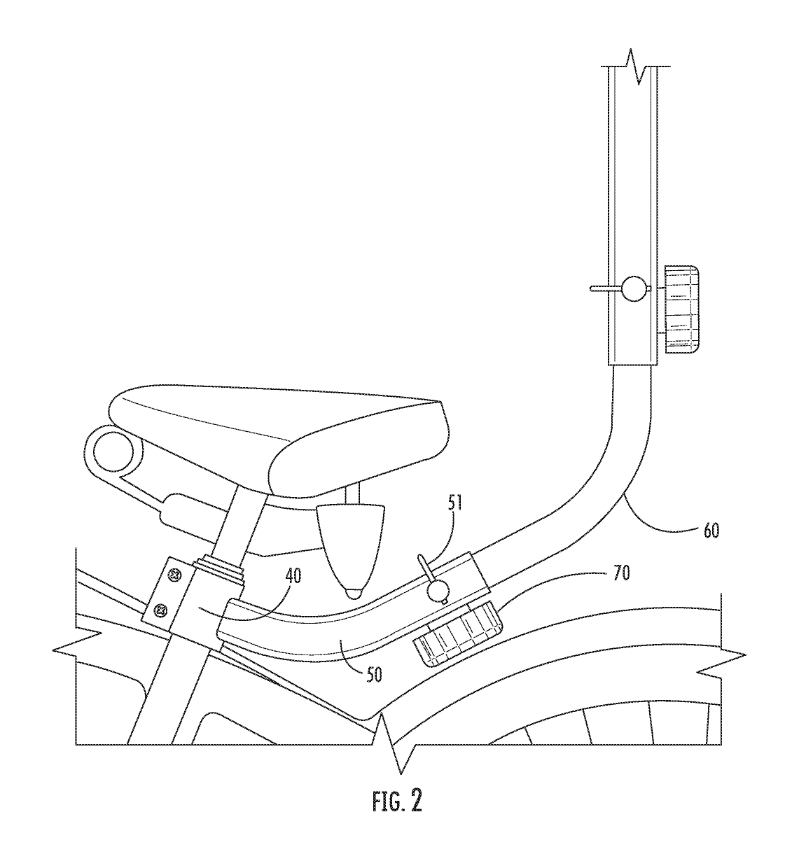

FIG. 2 is a more detailed transverse view of the bracket 40 that fastens the sunshade 10 to the bicycle 15. This shows a pin 51 in arm 50 that fixes the curved tube 60. Optionally a thumb screw 70 helps stabilize the curved tube 60 inside the arm 50. The head of the thumb screw 70 is enlarged for purposes of illustration. Curved tube 60 can be variably inserted into the arm 50, for a telescoping function. Not show are multiple holes in the curved tube 60 that permit adjustable length.

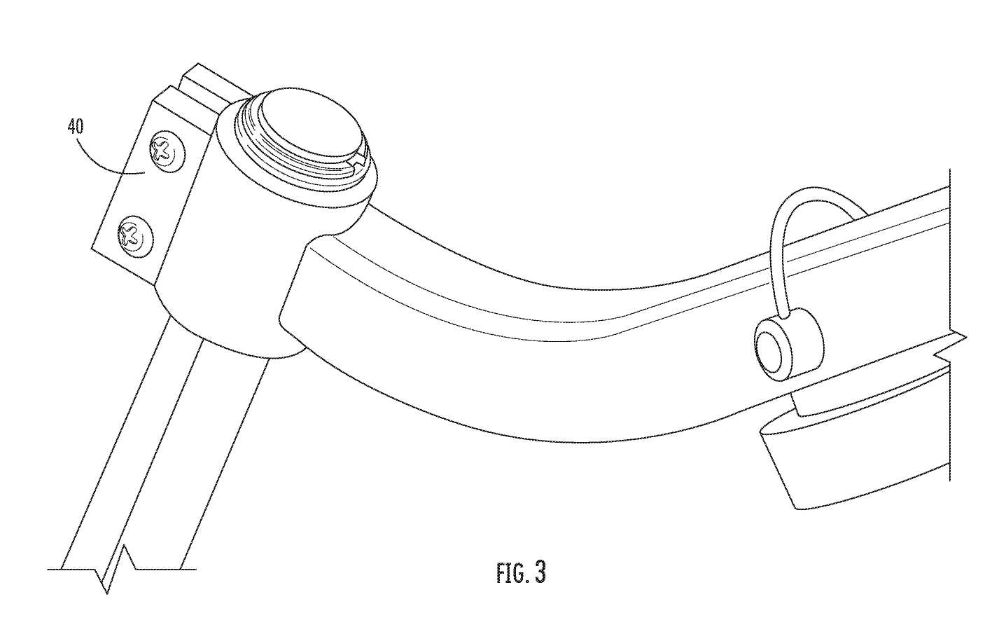

FIG. 3 shows the bracket 40 which can be adjusted with inserts (not shown). The inserts permit adjusting the bracket to adapt the sunshade 10 to many styles of bicycles.

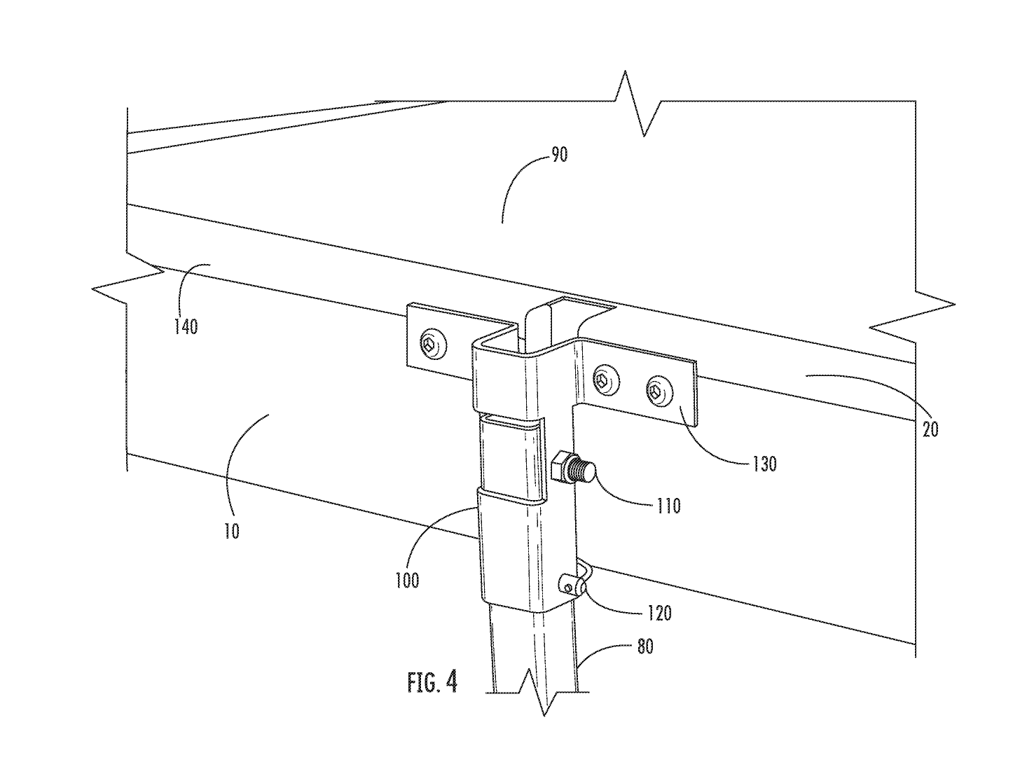

FIG. 4 is a transverse view of the rear of the assembled sunshade 10 and illustrates one way the sunshade can be folded. The screen 90 sits atop support pole 80 and is connected to the pole 80 via a tipping mechanism 100 which is shown connected permanently to the support pole 80 with a bolt 110, on which the screen 90 pivots. The weight of the screen 90 would pivot the tipping mechanism 110 without a pin 120 to keep it upright. The top of the tipping mechanism 100 has a plate 130 that can be screwed to a corresponding plate (not shown) supporting the screen 90. FIG. 4 also shows the screen 90, a valance 20 and optional trim 140 that can include batting, foam or other soft material to cushion upon contact.

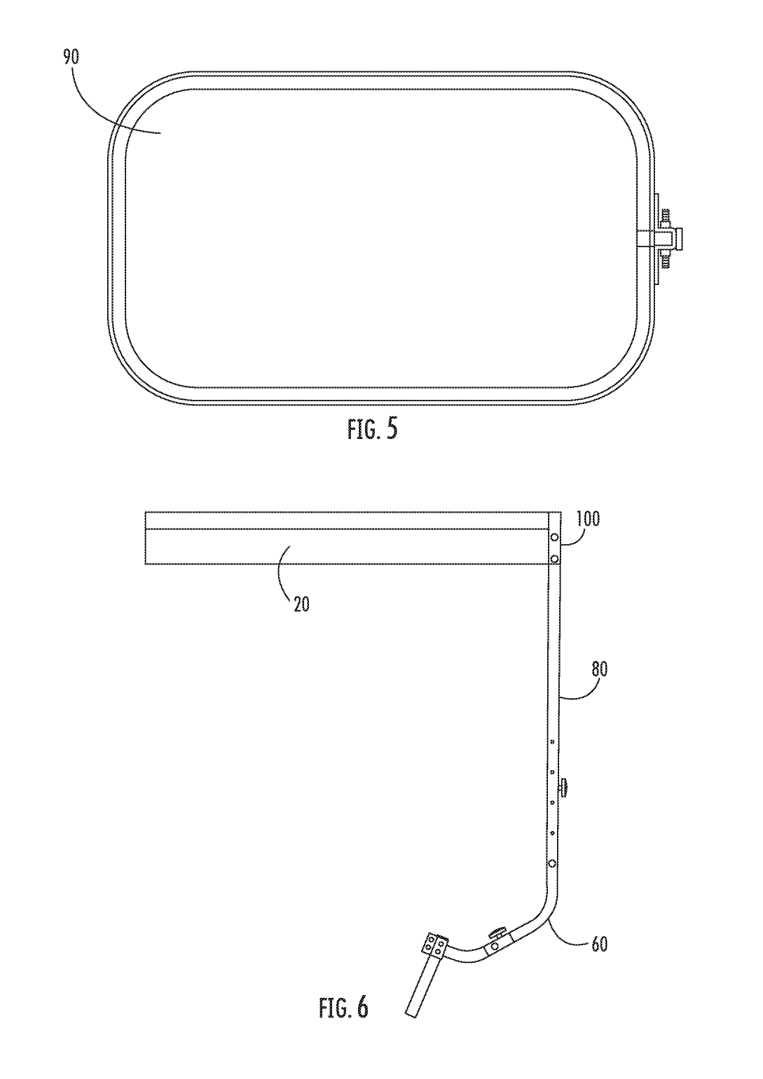

FIG. 5 shows an upper view of the screen 90 with attachment to the tipping mechanism 100. From end to end (tipping apparatus) the screen measures 39 inches. The screen is 24 inches from side to side. The screen 90 is preferably supported by a narrow cylinder with rounded corners.

FIG. 6 is a schematic of the support system for the sunshade 10. This shows the tipping mechanism 100 is preferably about 4-¾ inches. The support pole 80 is about 34-½ inches. The curved tube 60 has a straight section of about 27 inches. The support pole 80 can be slid upward about 12 inches, to still leave about 15 inches of the curved tube 60 inside.

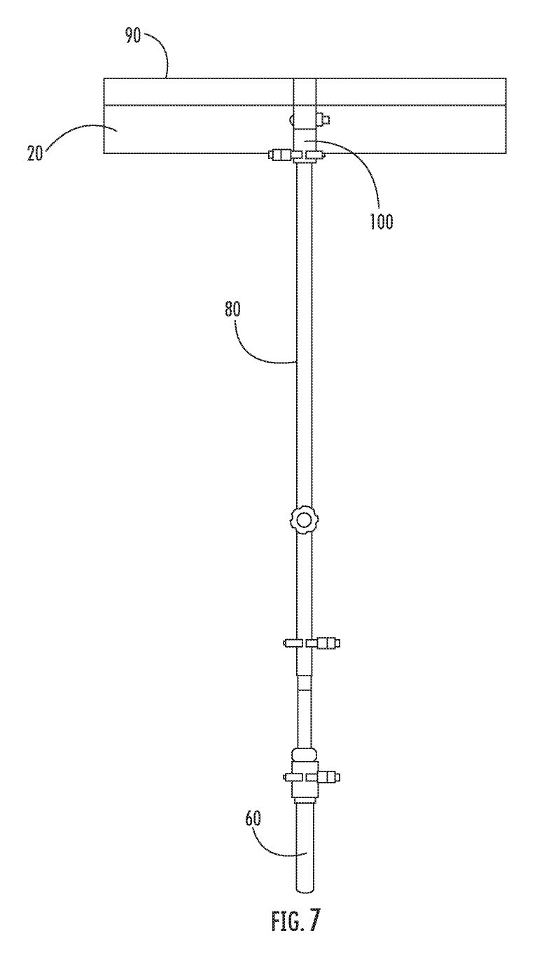

FIG. 7 is a rear plan view of the straight part of the hardware of the sunshade 20. At the bottom is the curved tube 60. In the middle is the support pole 80, and at the top connecting the support pole 60 with the screen 90 is the tipping mechanism 100.

The individual metal parts ( )are preferably machined or molded and can include but are not limited to steel, aluminum and polyvinyl chloride (PVC). Preferred for the rods is extruded aluminum.

The screen is preferably made of a plastic mesh, which may be extruded, oriented, expanded, woven or tubular. The mesh can be made from polypropylene, polyethylene, PVC, PTFE, polyester, nylon or cotton mesh, or a combination thereof. For added strength, metallic threads can be uses therein. The mesh is chosen based on sun blockage and air transmission. Alternatively, when air transmission is not a factor, a wide variety of strong fabrics can be used as screens, including but not limited to canvas, cotton, polyester, wool, viscose and silk.

The valance and trim cover can be the same material as the screen. Alternately, the valance can be made of a variety of fabrics that let air through and decrease drag and include but are not limited to lace, eyelet and pointelle materials. Such are chosen for their appearance and air passage.

The sunshade is assembled by starting with removing the bicycle seat and determining which bracket to use on the seat post. The bracket is tightened around the seat post and the bicycle seat re-installed. The curved tube is inserted into the bracket and arm. The screen portion is attached to the tipping mechanism and open up. The support pole is placed over the curved tube and adjusted for height and the pin is inserted. Optional thumb screws are tightened.

The present invention is described above with reference to illustrative embodiments. However, those skilled in the art will recognize that changes and modifications may be made in the described embodiments without departing from the nature and scope of the present invention. Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A bicycle sunshade, comprising:
a bracket to attach to a bicycle seat post, the bracket having an arm to accept a curved tube, whose opposite end is straight and fits inside a support pole, the curved tube and support pole having holes for pins to secure the tube and pole to each other;
a tipping mechanism that fits over the support pole, the tipping mechanism comprising a tube with a side hole accommodating the top of the support pole as the tipping mechanism pivots;
the tipping mechanism and support pole being secured by a bolt that serves as a fulcrum;
the tipping mechanism further attaching to a plate to engage the screen; and
the screen portion comprising a perimeter tube, the perimeter tube supporting a valance and attaching to the perimeter of the screen.
